(19) United States
(12) Patent Application Publication
(10) Pub. No.: US 2018/0306385 A1
(43) Pub. Date: Oct. 25, 2018

(54) Parallel Utility Installation Apparatus And Method

(71) Applicant: The Charles Machine Works, Inc., Perry, OK (US)

(72) Inventors: Kelvin P. Self, Stillwater, OK (US); Scott B. Cole, Edmond, OK (US); Michael F. Gard, Perry, OK (US); Richard F. Sharp, Perry, OK (US)

(21) Appl. No.: 15/962,517

(22) Filed: Apr. 25, 2018

Related U.S. Application Data
(60) Provisional application No. 62/489,815, filed on Apr. 25, 2017.

(51) Int. Cl. F17D 5/06; E02F 5/02; E02F 5/14; E02F 5/10; G05D 1/02; B62D 6/00; G01M 3/40

(52) U.S. Cl. CPC F17D 5/06; E02F 5/027; E02F 5/14; E02F 5/145; E02F 5/102; E02F 5/06; G05D 1/0265; B62D 6/001; G01M 3/40; E02F 5/103; G05D 1/0212

(57) ABSTRACT

A method and apparatus for installing a monitoring cable or other utility near an existing pipeline. An electromagnetic signal may be induced on the pipeline. Sensors disposed on an installation vehicle communicate with a processor to determine a distance and orientation of the vehicle relative to the pipeline. A plow or other digging tool opens a trench and installs the cable along a path disposed next to the pipeline within an acceptable distance range from the pipeline. The vehicle may be remotely or automatically operated.

### FIELD

The present invention relates generally to an apparatus and method for installing a monitoring cable proximate an in-situ pipeline.

### SUMMARY

The present invention is directed to an apparatus for installing a line along a length of buried pipeline. The apparatus comprises a machine frame, a plow, a first proximity sensor, and a second proximity sensor. The machine frame comprises at least one ground engaging drive member, and defines a first and second end and longitudinal centerline. The plow is disposed on the second end of the frame. The first and second proximity sensors are longitudinally spaced and both capable of detecting a magnetic field emanating from the buried pipeline.

The present invention is further directed to a method. The method comprises inducing an electromagnetic signal on a length of buried pipeline and translating a mobile machine along the length of the buried pipeline. The magnetic signal is detected at the mobile machine frame as it translates along the length of pipeline. The signal is used to maintain the machine frame along a path a desired distance range away from the buried pipeline. The method further comprises opening a trench along the path as the machine frame is translated along the length of the pipeline and installing a line within the trench.

The invention is further directed to a system comprising a pipeline, a monitoring line, and a processor. The monitoring line is disposed at a distance of less than ten feet from the pipeline and carries a signal along its length. The processor is in communication with the monitoring line and detects interruptions or abnormalities in the signal. The monitoring line and pipeline are at least partially underground. At the onset of the second residence time, the pipeline contains a flowing material.

### BRIEF DESCRIPTION OF THE DRAWINGS

FIG. 1 is a top view of a cable installation machine disposed near a footprint of a buried pipeline.

FIG. 2A is a diagrammatic representation of a top view of a system for monitoring a pipeline.

FIG. 2B is a diagrammatic representation of a side view of the system of FIG. 2A.

FIG. 3A is a side view of a plow blade having a trailing sensor.

FIG. 3B is a side view of a plow blade having an embedded sensor.

FIG. 3C is a side view of a plow blade having two embedded sensors.

FIG. 4 is an alternative cable installation machine having two sensors on a forwardly-disposed outrigger.

FIG. 5 is an alternative cable installation machine having front and rear sensor arrays disposed about the longitudinal axis of the machine.

FIG. 6A is a side view of a trencher boom having sensors in a restraint arm.

FIG. 6B is a side view of a trencher boom having sensors within the boom.

FIG. 7 is the cable installation machine of FIG. 1 disposed above a curving buried pipeline.

### DETAILED DESCRIPTION

Pipelines transmit a flowing material, such as water, crude oil or natural gas, from one location to a distant location. Such pipelines must be monitored to detect leaks, nearby digging activity, and the like. Pressurized liquid or gas may rapidly expand from any breach of the pipeline. Leaks could cause environmental damage and loss of valuable product, and could lead to safety hazards. Any digging activity that does not take particular care to avoid the pipe risks causing the same hazards.

In recent years, monitoring systems have been developed to remotely monitor a condition of the pipeline, which may include leaks and nearby digging. For example, fiber optic cable or other sensor lines, laid along the length of a pipeline, carry a signal between spaced nodes. When the signal is interrupted or distorted, software interprets that disruption to determine the nature and location of a hazard. Such real-time monitoring can allow quick mitigation of the hazard.

While new installations of pipelines allow for easy installation of such monitoring lines during the installation process, many thousands of miles of such pipelines exist without monitors. The present invention provides a way to install monitors, such as fiber-optic monitoring lines, next to pre-existing pipelines.

Much of the difficulty in such installation is due to the nature of oil and gas pipelines. Pipelines are typically installed with 3 to 6 feet of groundcover. Oil pipelines range in diameter from 6 to 48 inches. Gas pipelines range in diameter from 16 to 48 inches, and may be at 200 to 1500 psi. While maps of active lines typically exist, vital data, such as the diameter of the pipe, lateral junctions, y- and t-joints left for expansion, location of curves, etc., may not be included. Additionally, what data there is may be rendered unreliable by uncertainty, soil erosion, or migration of the pipe due to the passage of time.

Thus, whether a pipeline has been installed 6 months, 10 years, or half a century prior to an installation, any installation of a monitoring line next to a pipeline is problematic for several reasons.

Additionally, to be effective, fiber lines should be installed from 18 inches to 6 feet away from the pipeline. Urban and suburban utility easements may limit the maximum separation possible. For gas lines, the preferred installation position for leak detection may be at 10 o'clock or 2 o'clock relative to the pipeline. For oil lines, the preferred position may be at 5 o'clock or 7 o'clock. The optimal position for detecting digging may be directly above the pipeline. In each of these cases, a monitoring line will be less effective with distance from the pipeline.

Fiber lines and similar monitoring lines may be installed by conventional vibratory plows, trenchers, horizontal directional drills and other methods. However, as detailed above, the underground pipe's location is unpredictable and an inadvertent strike of the line could be catastrophic.

A charge or electromagnetic signal may be induced on the oil or natural gas pipeline, as many of these pipelines are made of a conductive material, like steel. When made of non-conductive material such as plastic, a tracer wire is buried alongside the pipeline to facilitate pipeline location by inducing a charge or signal on the wire. A signal transmitter may be attached to such tracer wire or conductive pipelines to impress or induce a signal along its length. Such active locating causes a pipe to be “illuminated” such that locating devices can detect the signal as it emanates from the pipe.

Due to the relatively large diameters of some oil and gas pipelines, and the relatively close distance at which a monitoring line needs to be installed, an “illuminated” pipe may appear less like a filament and more like a surface to locating devices. Additionally, tees, elbows, pipe taps and other anomalies may render the pipe non-cylindrical in stretches. Thus, error will be associated with an estimated centerline or an estimated outside edge of a detected pipe. The system disclosed herein accounts for such error when installing a monitoring line near a previously installed pipeline.

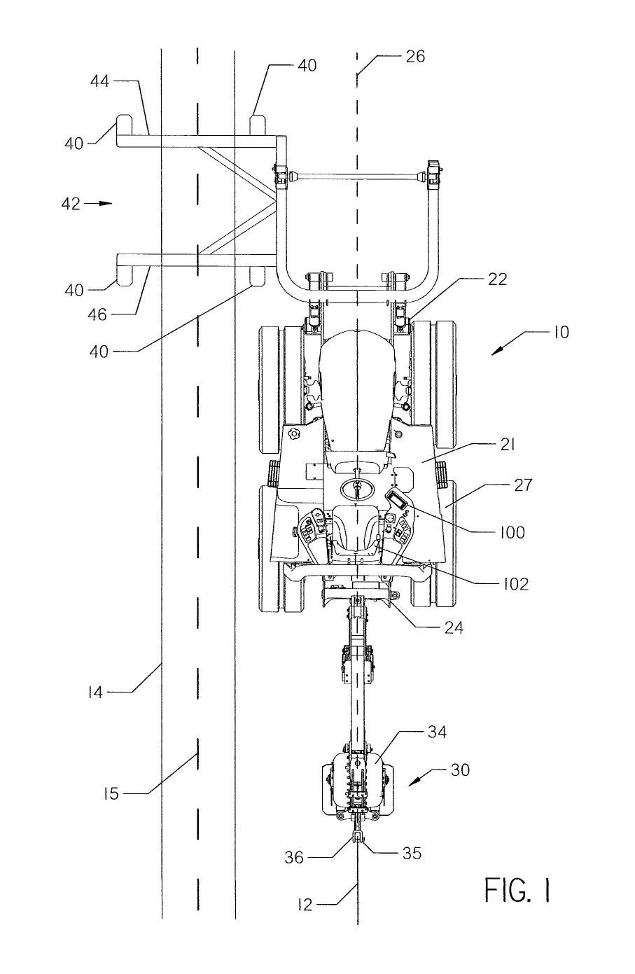

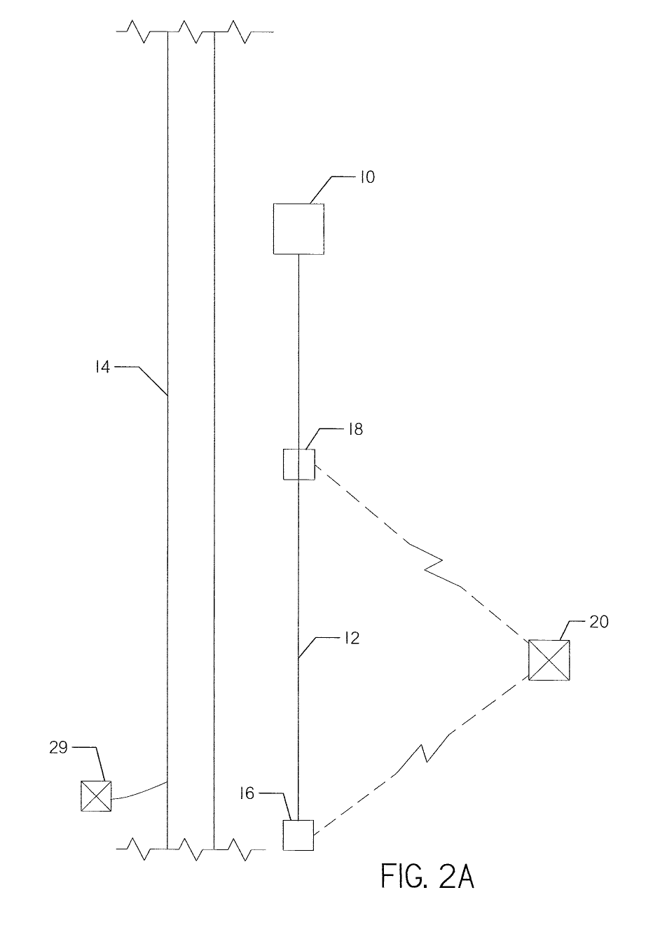

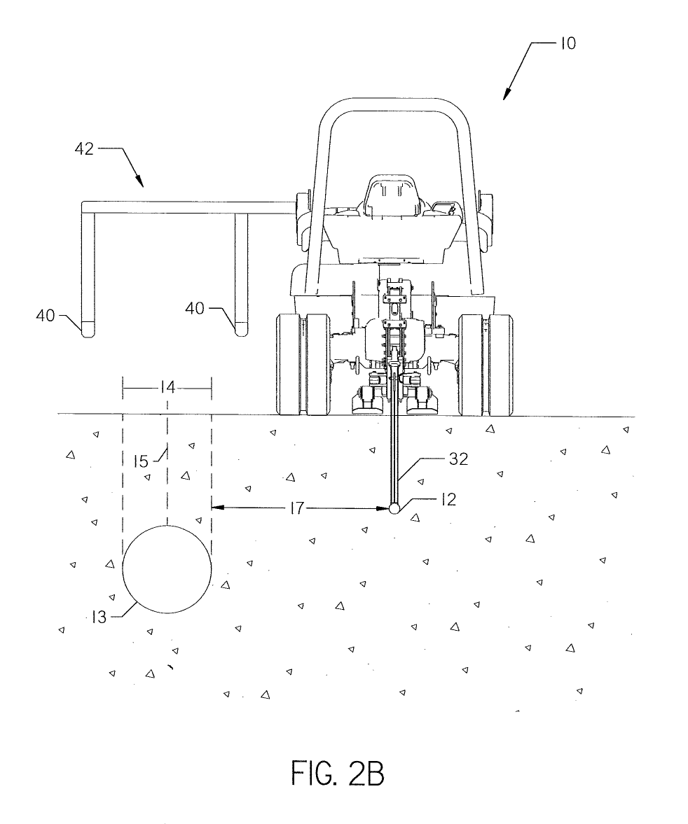

With reference to FIG. 1, an apparatus for installing a line substantially parallel to an existing pipeline is shown. An installation machine 10 is shown installing a monitoring cable 12 proximate a buried pipeline 13 (FIG. 2B). A footprint 14 of the buried pipeline 13 is projected on a surface of the ground. A centerline 15 of the buried pipeline 13 is likewise shown projected on a surface of the ground. It should be understood that the pipeline may be installed 3 to 6 feet beneath the footprint 14.

The monitoring cable 12 may be of a type known in the industry to detect external hazards, leaks, or internal degradation of the pipeline. Such cables are typically fiber optic, though some cables may include specialized sensing cables or sensors which sense a physical change in pipeline operation. This physical change could be a leak, change in temperature, vibration or other physical phenomenon. In operation of the system, as shown in FIG. 2A, signals are sent along the monitoring cable 12 from a first node 16 to a distant second node 18. Typically, such a signal is a series of light pulses, though it could include electrical signals or other methods of communicating a change in physical state. It should be understood that a great many nodes may cooperate along a length of monitoring cable. Each node 16, 18 may be up to a kilometer or more apart. Alternatively, said cable could be comprised of specialized sensors which detect one or more characteristics of improper pipeline operation space all along the cable.

The second node 18 sends data indicative of the received signal to a monitoring processor 20. The monitoring processor 20 analyzes the received signal for a change in pipeline operation indicating an interruption or distortion. Such an interruption or distortion will determine the location and nature of a hazard. Remedial or preventive measures may be taken at the precise location of the hazard.

As shown in FIG. 2B, the pipeline 13 is disposed with the monitoring cable 12 at approximately the 2 o'clock position. The cable 12 is a distance 17 away from the edge of pipeline 13. This distance 17 should be within a range between a maintained minimum gap and maximum distance. The maximum distance between the pipeline 13 and monitoring cable 12 to allow the cable 12 to be effective may be between 6 and 10 feet. Likewise, for new monitoring cable installations, a minimum gap to minimize the risk of a strike between installation devices and the pipeline 13 may be between 12 and 24 inches.

In prior art systems, the monitoring cable 12 and pipeline would need to be installed at the same time. This is due to difficulties in installing a monitoring cable 12 underground near the footprint 14 of a previously buried pipeline. However, due to the installation machine 10, a monitoring cable 12 may be installed in proximity to a pipeline with a residence time of more than six months to a year. In some instances, pipelines will have been in place for decades prior to installation of the monitoring cable 12.

With reference again to FIG. 1, the installation machine 10 comprises a frame 21. The frame 21 has a front end 22, a rear end 24, and a longitudinal axis 26 disposed along its centerline. The machine frame 21 is translated across a surface of the ground by one or more ground drive members 27. As shown, the installation machine 10 comprises four tracks.

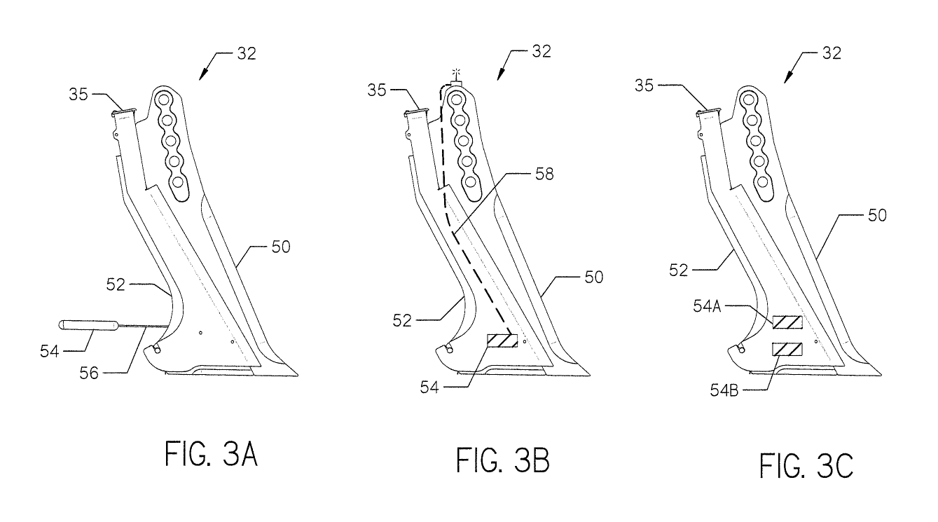

The installation machine 10 comprises a plow assembly 30 disposed at the rear end 24 along the longitudinal axis. The plow assembly 30 comprises a plow blade 32 (FIGS. 3A-3C), a vibrator assembly 34, and a cable guide 35. The vibrator assembly 34 imparts a vibration to the plow blade 32 to open a trench for placement of the monitoring cable 12. The cable guide 35 provides a channel 36 for feeding the monitoring cable 12 into the trench.

The installation machine 10 further comprises at least one sensor 40 disposed on the frame. Preferably, the installation machine 10 comprises a plurality of sensors. The plurality of sensors 40 may be spaced longitudinally relative to the frame 12. The sensors 4o may alternatively, or in addition, be spaced laterally about the frame or vertically relative to the surface of the ground.

In any case, sensors 4o are operatively connected to a processor 100. The processor 100 analyzes signals received by the sensors 40 as will be further described below, and uses those signals to determine the distance and orientation of the pipeline relative to plow, and display or make operational or steering adjustments in response. The processor 100 may be included onboard the machine 10 as shown in FIG. 1, or may be remote. The processor 100 may control the machine 10 directly, or may provide information to an operator at an operator station 102 located on the machine frame 21 or remotely located operator at a distant point removed from the machine.

The sensors 40 may be magnetometers, magnetoresistive devices, triaxial ferrite rods, triaxial air core antennas, or similar sensing devices in controlled geometries. A single point magnetic field decomposition may be used to determine the relative orientation of the pipeline from the sensor 12, but not necessarily separation distance. Using two or more spaced-apart sensors 40 may allow distance to be estimated and may provide steering input as the sensors 40 detect a change in the course of the footprint 14. The processor 100 may then instruct the machine 10 to maintain a relatively constant distance from the footprint. Alternatively, distance may be displayed to a machine operator, who steers the tractor to maintain the desired distance. The sensors 40 may be calibrated to a representative pipe segment to improve distance estimates obtained from the processor 100.

In one embodiment, shown in FIGS. 1, 2B, 4, 5 and 7, an array of sensors 40 are disposed on a sensor outrigger 42. The outrigger 42 is preferably positioned near the front of tractor 10 to provide distance input to processor 100. Outrigger 42 may be separated from the frame 21 to decrease the influence of the frame's steel on the sensors 40. The sensor outrigger 42 comprises a first arm 44 and a longitudinally spaced second arm 46.

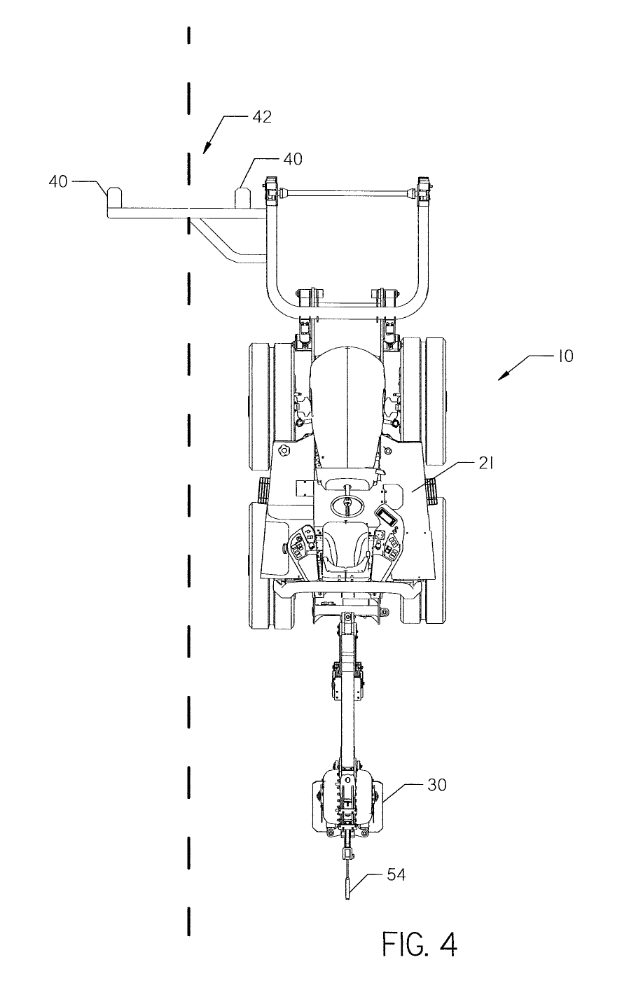

As shown, two sensors 40 are laterally spaced on the first arm 44 and two sensors are laterally spaced on the second arm 46. The arms 44, 46 of the sensor outrigger 42 may telescope to adjust the distance between sensors. This will be advantageous when changing the offset distance between tractor 10 and the pipe centerline 15. The outrigger 42 may alternatively comprise only one arm 44, as shown in FIG. 4. In FIG. 4, the sensors 40 of the outrigger 42 are used in conjunction with a proximity sensor 54 disposed near the plow assembly 30. Such configuration is shown in more detail in FIG. 3A.

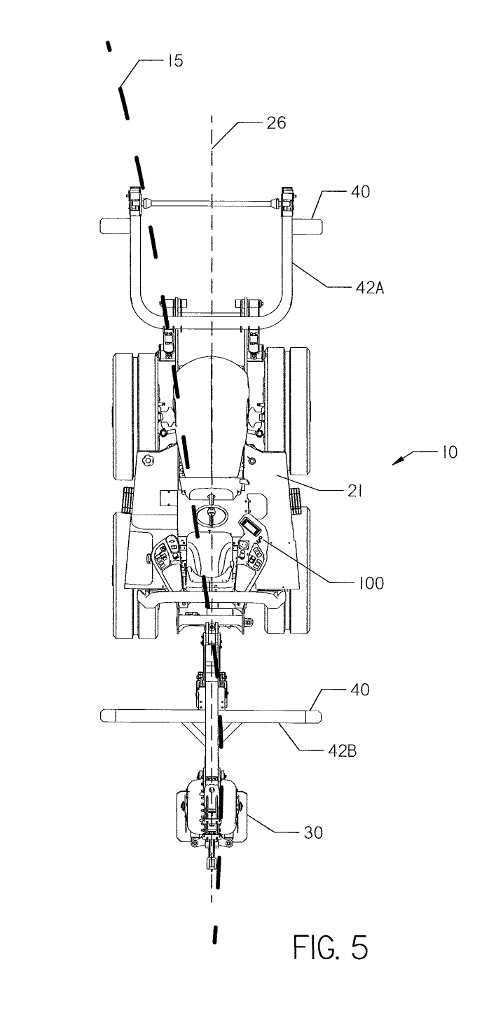

The outrigger 42 may be placed in line with the longitudinal axis 26 of the machine 10, as shown in FIG. 5. A front 42A and rear 42B outrigger are in line with the longitudinal axis 26 and the centerline 15. Such a configuration may be advantageous for positioning the monitoring line 12 directly above the pipeline 13. As shown in FIG. 5, the pipeline 13, as represented by centerline 15, is turning to the left, necessitating a steering adjustment by the processor 100.

In FIG. 1, the outrigger 42 is cantilevered relative to the machine 10 such that sensors 40 are disposed away from the machine frame 21 on a single side of the longitudinal axis 26 and on each side of the footprint 14. If the pipeline is magnetic or contains a conductive tracer wire, a locating signal may be placed on the pipeline by a transmitter 29 (FIG. 2A). Locating transmitters may produce locating steady-state signals at a plurality of possible frequencies. Thus, the sensors 40 should be capable of detecting the signal at more than one frequency. As used herein, “steady-state” should be understood to mean a consistent signal, though such a steady-state signal may vary in predetermined or predictable ways to aid in identification. Such methods may include by changing magnitudes, pulsing the signal on and off, and varying the frequency.

The sensors 40 disposed on opposite sides of the centerline 15 of footprint 14 may coordinate to indicate equivalent but opposite or balanced readings. Such a result indicates that the footprint 14 is centered between opposing sensors 40. The installation machine 10 may be steered as changes in the field are detected by the sensors 40 to maintain this “null” or balanced sensor 40 reading. By centering the footprint 14 and pipeline between a pair of sensors 40, a minimum distance between the pipeline and the plow blade 32 may be maintained.

While an outrigger 42 may be used with the installation machine 10, a separate vehicle (not shown) could contain the sensors 40 described above. The separate vehicle could either operate simultaneously with the installation vehicle 10, or could create a record of the footprint 14 for later use by the installation vehicle. This record may be a physical marker, such as a paint line, or a virtual marker, such as gps coordinates, virtual paint markers, or the like. A separate vehicle could communicate with the installation machine 10 via Bluetooth or similar communication methods to establish a preferred orientation when a monitoring cable 12 is being simultaneously installed.

With reference now to FIGS. 3A-3C, the plow blade 32 is shown in detail. The plow blade 32 comprises a blade edge 50, a trailing edge 52 and a proximity sensor 54. The blade edge 50 is the leading edge of the plow blade, and opens the trench. The trailing edge may include the cable guide 35 for installation of the monitoring line 12 within the opened trench.

The proximity sensor 54 may be of the same type as sensors 40, or may be a ferrite rod or other antenna capable of detecting the transmitted steady-state signal emanating from the pipeline. In FIG. 3A, the proximity sensor 54 is attached to the trailing edge 52 by a flexible or semi-rigid rod or cable 56. The cable 56 is capable of transmitting received signals to the processor 100.

FIG. 3B shows a sensor 54 formed within the plow blade 32 itself. As shown, a transmission cable 58 may be disposed within the blade 32. This cable 58 may transmit signals to the processor 100 directly or through a wireless connection. FIG. 3C shows two vertically displaced proximity sensors 54A and 54B. Vertical displacement of a known distance may aid in detection of a distance from the pipeline from the plow blade 32.

A suspended mass generator (not shown) or equivalent power source may be built into the plow blade 32 to provide power for the proximity sensor 54 and any corresponding electronics package in the blade structure.

The proximity sensor 54 is configured to provide an indication of separation from the pipeline. A generally decreasing separation distance, indicated by a strengthening received signal or other indicia, may indicate an approaching pipeline strike. The processor 100 may be configured to provide a minimum gap for the distance 17 (FIG. 2B), subject to error tolerances. This gap may be from 12 to 18 inches or more. The processor 100 detects that the distance between the plow blade is less than the minimum gap. The gap indication may be presented to an operator of the installation machine 10 as a quantified distance. Alternatively, the installation machine 10 may be stopped or automatically steered away from the pipeline by the processor 100.

Communication between the processor 100, steering systems on the machine 10, and the various sensors 40, 54 may be provided by wireless methods, such as Bluetooth. Alternatively, communication may be to a remote operator location some distance away from machine 10.

The plow blade 32 is preferably made of a non-magnetic alloy, such as Mangalloy, Nitronic 50 or Nitronic 60. Other such alloys may likewise be used. Further, pockets for installation of internal sensors such as in FIGS. 3B and 3C may be formed through laminar construction of the plow blade 32. In such cases, the sensors 54 may be positioned in the pocket and sealed in place with a wear resistant material such as polyurethane. Non-metallic plow blades 32 will limit interference with the received transmission at the proximity sensor 54.

The plow assembly 30 may comprise plow shoes, tires, or other devices to manually control the depth. The processor 100 may alternatively control plow depth based upon the detected position of the pipeline. In this configuration, the plow assembly 30 may be adjusted by a control system (not shown). The control system may comprise hydraulic cylinders (not shown) to control the maximum plow depth, and thus the depth of the trench in which the monitoring line 12 is installed. The control system responds to signals generated by the processor 100 to adjust plow depth based upon one or more factors such as pipe depth, blade depth, surface contour of the soil, plow location, position relative to an external laser plane, or others.

The sensors 40 and proximity sensor 54 may be responsive to cathodic protection signals commonly applied to metallic pipelines for reducing corrosion. Such a configuration allows existing pipeline signals to be used to locate the pipeline.

The installation machine 10 may be controlled remotely with the operator maintaining a distance from the footprint 14 of the pipeline. The machine 10 may follow a predetermined path, a paint line, a guide wire, or may be steered automatically due to the detected position of the pipeline.

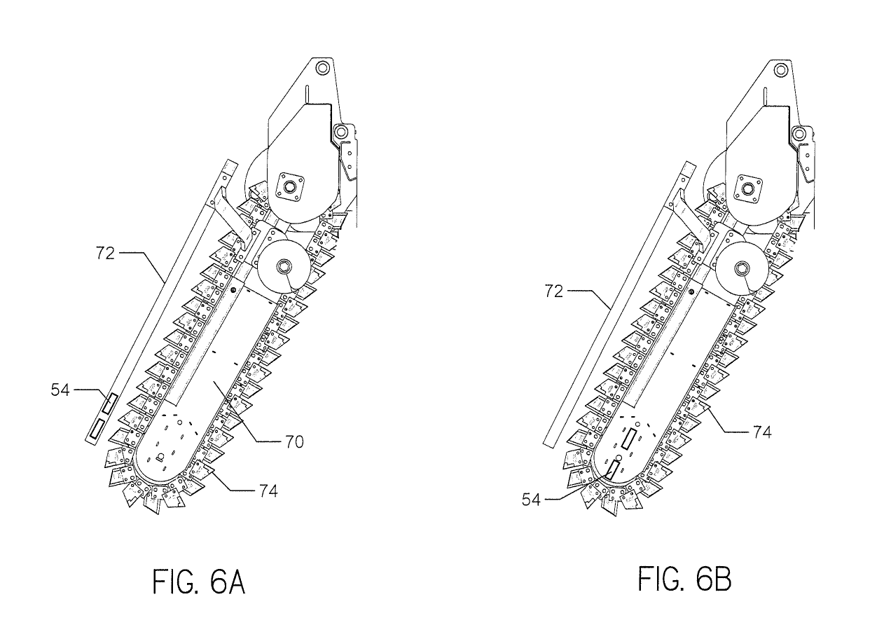

With reference to FIGS. 6A and 6B, one or more proximity sensors 54 may be placed within a trencher boom 70 rather than a vibratory plow. The proximity sensors 54 may be placed within a restraint bar 72 (FIG. 6A) or the trencher boom 70 itself (FIG. 6B). As with the plow assembly 30, the trencher boom 70, restraint bar 72, and trencher chain 74 may preferably be made of a nonmagnetic material to limit interference with the proximity sensors 54.

Use of a triaxial magnetometer as one or all of the sensors 40, 54 allows one of the three axes of the sensor 40, 54 to be aligned with the longitudinal axis 26. If the sensor 40, 54 is near a filamentary conductor, this axial measurement will be null when the longitudinal axis 26 and the conductor are parallel. However, as the pipeline size increases, its field will not approximate a filament. Therefore, the use of several redundant sensors and measurements described herein will aid in maintaining a parallel installation of the monitoring cable 12 at a desired distance from the pipeline 13.

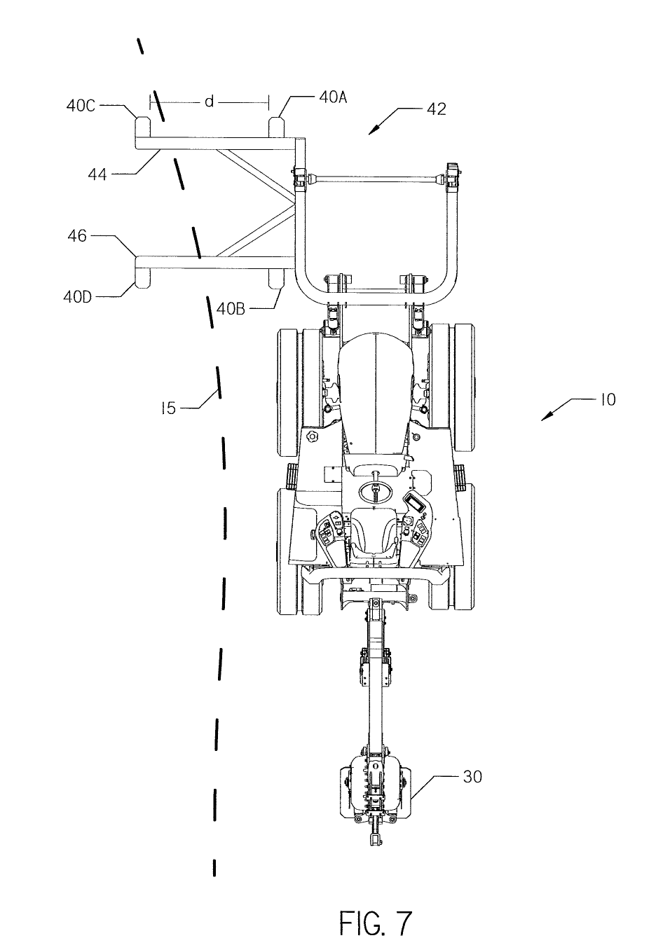

With reference to FIG. 7, the installation machine 10 of FIG. 1 is shown with the pipeline 13 turning, necessitating a steering step. The processor 100 detects a magnetic field emanating from the pipeline 13 at at least four discrete points, a first and third sensor 40A, 40C disposed on the front arm 44, and a second and fourth sensor 40B, 40D disposed on the rear arm 46.

The sensors 40A-D are disposed a known distance d away from each other on each respective arm 44, 46. Thus, each pair of sensors 40A, 40C and 40B, 40D is optimally a distance d/2 away from a position directly above the centerline 15 of the pipeline.

The processor 100 wishes to maintain the centerline 15 of the pipeline at equal distances from the first sensor 40A and third sensor 40C. However, in FIG. 7 sensor 40C is closer to the centerline 15 than sensor 40A. The departure from optimal is given as an error ε. The error ε is positive in the direction of 40A and negative in the direction of 40C.

The processor 100 may then determine a steering control response. As the error e should be less than d/2. The steering control response can be illustrated by considering the case where two sensors 40A-D are coplanar with a filamentary line. In such a case, the processor's steering response would be given by:

$$Response = \frac{8 ɛ}{{( \frac{d}{2} )}^{2} - 4 {( ɛ )}^{2}}$$

In a practical geometry, the response is complicated by the fact that the pipeline and sensors are not coplanar, and by the possibility that the pipeline has a diameter sufficiently large that it may not be treated as a filament. The general appearance of the steering response will, however, be similar in its general features to the mathematical relationship given above. In particular, a steering control will produce a signal when ε=0.

By detecting the error between sensors 40A-D disposed both at the front arm 44 and rear arm 46, the processor 100 will determine not only that a turn to the left is required, but also the magnitude of the steering correction in degrees based upon the errors in the front and rear sensors 40A-D.

The sensor orientation of FIG. 7, especially if used in conjunction with other sensors, such as a proximity sensor 54 (FIG. 5), may enable other “paired” sensors to create useful readings to aid the processor 100 in determining the position of the pipeline 13 and steering steps.

Changes may be made in the construction, operation and arrangement of the various parts, elements, steps and procedures described herein without departing from the spirit and scope of the invention as described in the following claims.

1. A system comprising:
an elongate pipeline section that has been situated underground for a first residency time;
an elongate monitoring line that has been situated underground for a second residency time, extends in a generally parallel relationship to the pipeline section, and is configured to carry a steady-state signal indicative of a condition of the pipeline section;
a processor in communication with the monitoring line and configured to respond to disruption of the steady-state signal;
in which elongate pipeline section contains a flowing material at the beginning of the second residency time.

2. The system of claim 1 in which the first residency time is at least one year longer than the second residency time.

3. The system of claim 1 in which the monitoring line is a fiber optic line.

4. The system of claim 3 in which the steady-state signal comprises a light pulse.

5. The system of claim 1 in which the pipeline contains compressed natural gas.

6. The system of claim 1 in which the monitoring line is situated no more than ten feet from the pipeline section.

7. The system of claim 1 in which the monitoring line is comprised of one or more sensors.

8. The system of claim 7 in which the steady-state signal comprises an electrical signal.

9. The system of claim 1 in which the flowing material is a pressurized liquid.

10. An apparatus comprising:
a machine frame;
a motive system suspended from the machine frame and configured to maneuver the machine on a ground surface;
a plow supported on machine frame; and
a sensor assembly comprising:
a sensor frame supported by the machine frame; and
a first pair of magnetic field sensors supported by the sensor frame and maintainable at a fixed separation distance.

11. The apparatus of claim 10 in which the motive system comprises:
an array of ground-contacting powered motive elements situated entirely within a footprint;
in which the first pair of magnetic field sensors are situated in non-overlying relationship to the footprint.

12. The apparatus of claim 10 further comprising a rear magnetic field sensor supported by the plow.

13. The apparatus of claim 12 wherein the rear magnetic field sensor is located within a pocket in the plow.

14. The apparatus of claim 10 in which the sensor assembly further comprises a second pair of magnetic field sensors supported by the sensor frame and maintainable at a fixed separation distance.

15. The apparatus of claim 10 in which the sensor frame is characterized as a first sensor frame and in which the sensor assembly further comprises:
a second sensor frame supported by the machine frame; and
a second pair of magnetic field sensors supported by the second sensor frame and maintainable at a fixed separation distance.

16. The apparatus of claim 15 in which the first and second sensor frames are disposed on the same side of the machine frame.

17. The apparatus of claim 15 in which the first and second sensor frames each comprise an arm, wherein the arm of the first sensor frame supports the first pair of magnetic field sensors and the arm of the second sensor frame supports the second pair of magnetic field sensors and wherein the first arm and second arm are substantially parallel.

18. The apparatus of claim 10 in which each magnetic field sensor is a triaxial magnetometer.

19. The apparatus of claim 10 in which the sensor frame cantilevers from the machine frame.

20. The apparatus of claim 19 in which the sensor frame telescopes to position the magnetic field sensors at a fixed distance from the machine frame.

21. A system comprising:
a terrain having a ground surface;
a pipeline situated below the ground surface of the terrain and producing a characteristic magnetic field; and
the apparatus of claim 10, situated above the terrain such in which the motive system contacts the ground surface and each of the sensors is within the receptive range of the magnetic field.

22. The apparatus of claim 10 further comprising a processor in communication with the first pair of magnetic field sensors configured to estimate the distance between the plow and a magnetic field source in communication with the sensors.

23. The apparatus of claim 22 further comprising an alarm configured to send an alert signal when the estimated distance between the plow and the magnetic field source in communication with the sensors is less than 12 inches.

24. The apparatus of claim 23 in which the alert signal terminates all operation of the plow and the motive system.

25. A method comprising:
inducing a flow of a locating current within a section of a buried pipeline;
translating a mobile machine frame on the ground overlying the buried pipeline section while the locating current is flowing;
monitoring the magnetic field associated with the locating current at the mobile machine frame as it translates above the buried pipeline section; and
causing the machine frame to travel on a path upon which the signal produced by the magnetic field associated with the locating current does not vary from a predetermined range.

26. The method of claim 25 in which the signal produced is indicated by a signal strength.

27. The method of claim 25 in which the signal produced by the magnetic field is indicated by a comparison between multiple sensors disposed on the mobile machine frame.

28. The method of claim 25 further comprising:
causing the machine frame to travel on a path upon which strength of the magnetic field associated with the locating current does not fall below a predetermined level.

29. The method of claim 25 further comprising:
opening a trench along the path as the machine frame translates on the ground; and
installing a line within the trench.

30. The method of claim 29 further comprising detecting a condition of the buried pipeline with the line.

31. The method of claim 29 in which the trench has a depth of more than 6 inches and less than 36 inches.

32. The method of claim 29 in which the line is installed as the machine frame translates.

33. The method of claim 25 wherein the machine is automatically maintained along the path by a steering controller as it translates on the ground overlying the buried pipeline.
